(19) United States
(12) Patent Application Publication
(10) Pub. No.: US 2009/0097293 A1
(43) Pub. Date: Apr. 16, 2009

(54) HIGH-FREQUENCY POWER SUPPLY

(76) Inventor: Shuai CHANG, Shenyang (CN)

Correspondence Address: EDWARDS ANGELL PALMER & DODGE LLP, P.O. BOX 55874, BOSTON, MA, 02205, US

(21) Appl. No.: 12/025,307

(22) Filed: Feb. 4, 2008

(30) Foreign Application Priority Data
Oct. 10, 2007 (KR) 10-2007-101944

(51) Int. Cl. H02M 7/521

(52) U.S. Cl. 363/136

(57) ABSTRACT

A plurality of half-wave bridge type oscillators are operated in a time-sharing method and connected through primary windings of a transformer to make the reverse bias hold time of each thyristor long. Therefore, it is possible to stably output a frequency and power which are several times as high as those in a conventional power supply.

### CROSS-REFERENCE TO RELATED APPLICATION

This application claims under 35 U.S.C. §119(a) the benefit of Korean Patent Application No. 10-2007-101944 filed Oct. 10, 2007, the entire contents of which are incorporated herein by reference.

### BACKGROUND

1. Technical Field

The present invention relates to a high-frequency power supply, and more particularly to a high-frequency power supply configured to stably output high power of a high frequency band through the use of a thyristor in an induction heating field.

2. Background Art

A high-frequency power supply for use in induction heating is generally implemented with a single-phase full-wave bridge circuit having a structure as shown in FIG. 8. However, this single-phase full-wave bridge circuit has a limitation in generating more than a certain frequency in that the reverse bias hold time of a thyristor is short as shown in FIG. 9.

### SUMMARY OF THE DISCLOSURE

Therefore, the present invention has been made in view of the above problems, and it is an object of the present invention to provide a high-frequency power supply in which a plurality of half-wave bridge type oscillators are operated in a time-sharing method and connected through primary windings of a transformer to make the reverse bias hold time of each thyristor long as shown in FIG. 6, thereby making it possible to output a frequency and power which are several times as high as those in a conventional power supply, using a thyristor having the same turn-off time characteristic tq.

In accordance with an aspect of the present invention, a high-frequency power supply comprises, as shown in FIG. 1, a direct current (DC) voltage source, a transformer having two primary windings connected respectively to the anode and cathode of the DC voltage source and a secondary winding cooperating with the two primary windings for providing a high-frequency output, and a plurality of half-wave bridge type oscillators connected to the two primary windings of the transformer and the anode and cathode of the DC voltage source so as to be operated in a time-sharing method.

Each of the half-wave bridge type oscillators may include a first thyristor and second thyristor connected in series between the two primary windings of the transformer, and a first capacitor and second capacitor connected in series between the anode and cathode of the DC voltage source and having an intermediate connection point connected to an intermediate connection point of the first thyristor and second thyristor.

The first and second thyristors may be implemented by thyristors having only a turn-on capability or other types of thyristors having both turn-on and turn-off capabilities, such as a gate turn-off (GTO) thyristor.

In order to prevent an inductive kick from being applied to each of the first and second thyristors, each half-wave bridge type oscillator may further include, as shown in FIG. 3, a first fast recovery element connected in series to the first thyristor, a first resistor connected in parallel with the first fast recovery element, a second fast recovery element connected in series to the second thyristor, and a second resistor connected in parallel with the second fast recovery element.

The first and second fast recovery elements may be implemented by diodes or thyristors having a faster reverse recovery time characteristic trr than the series-connected first and second thyristors.

In accordance with another aspect of the present invention, a high-frequency power supply comprises, as shown in FIG. 2, a DC voltage source, a transformer having a plurality of primary windings and a secondary winding cooperating with the primary windings for providing a high-frequency output, and a plurality of half-wave bridge type oscillators connected respectively to the primary windings of the transformer and connected to the anode and cathode of the DC voltage source so as to be operated in a time-sharing method.

Each of the half-wave bridge type oscillators may include a first thyristor and second thyristor connected in series between the anode and cathode of the DC voltage source, and a first capacitor and second capacitor connected in series between the anode and cathode of the DC voltage source and having an intermediate connection point connected to an intermediate connection point of the first thyristor and second thyristor through a corresponding one of the primary windings of the transformer.

The first and second thyristors may be implemented by thyristors having only a turn-on capability or other types of thyristors having both turn-on and turn-off capabilities, such as a GTO thyristor.

In order to prevent an inductive kick from being applied to each of the first and second thyristors, each half-wave bridge type oscillator may further include, as shown in FIG. 4, a first fast recovery element connected in series to the first thyristor, a first resistor connected in parallel with the first fast recovery element, a second fast recovery element connected in series to the second thyristor, and a second resistor connected in parallel with the second fast recovery element.

The first and second fast recovery elements may be implemented by diodes or thyristors having a faster reverse recovery time characteristic trr than the series-connected first and second thyristors.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a circuit diagram of a high-frequency power supply according to one embodiment of the present invention;

FIG. 2 is a circuit diagram of a high-frequency power supply according to an alternative embodiment of the present invention;

FIG. 3 is a circuit diagram showing the addition of an inductive kick prevention circuit to the circuit diagram of FIG. 1;

FIG. 4 is a circuit diagram showing the addition of an inductive kick prevention circuit to the circuit diagram of FIG. 2;

FIG. 5 is a circuit diagram of an embodiment based on FIG. 3;

FIG. 6 is a voltage waveform diagram of a thyristor in FIG. 5;

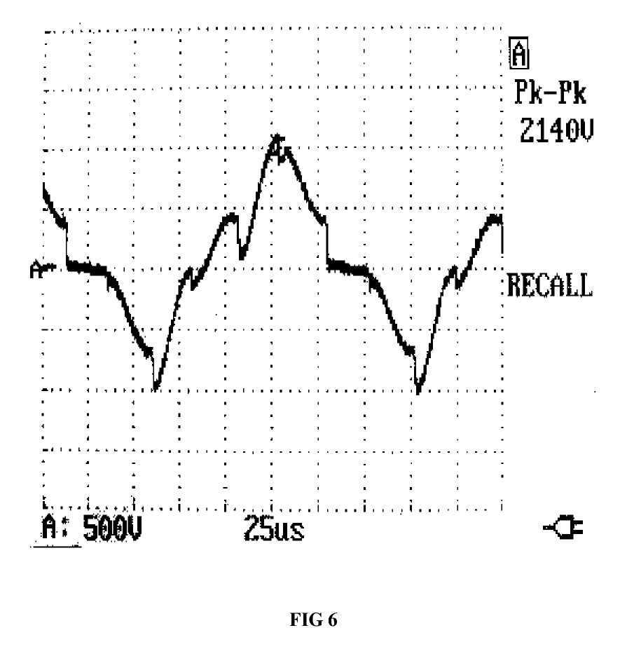

FIG. 7 is a circuit diagram illustrating the principle of a circuit which prevents an inductive kick from being applied to a thyristor;

FIG. 8 is a circuit diagram of a conventional high-frequency power supply; and

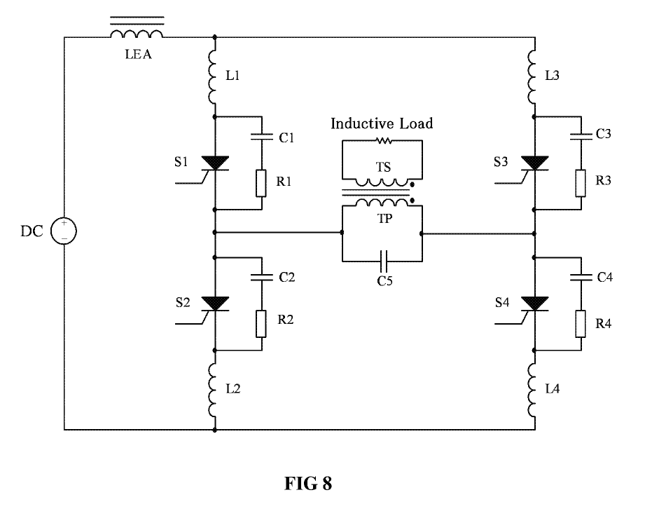

FIG. 9 is a voltage waveform diagram of a thyristor in FIG. 8.

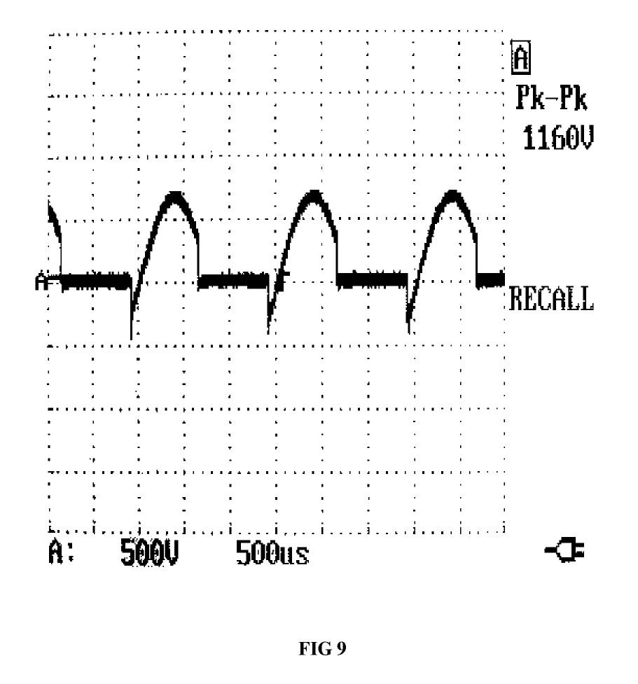

### DETAILED DESCRIPTION

Reference will now be made in detail to the preferred embodiments of the present invention, examples of which are illustrated in the accompanying drawings. In the following description of the present invention, a detailed description of known functions and configurations incorporated herein will be omitted when it may make the subject matter of the invention rather unclear.

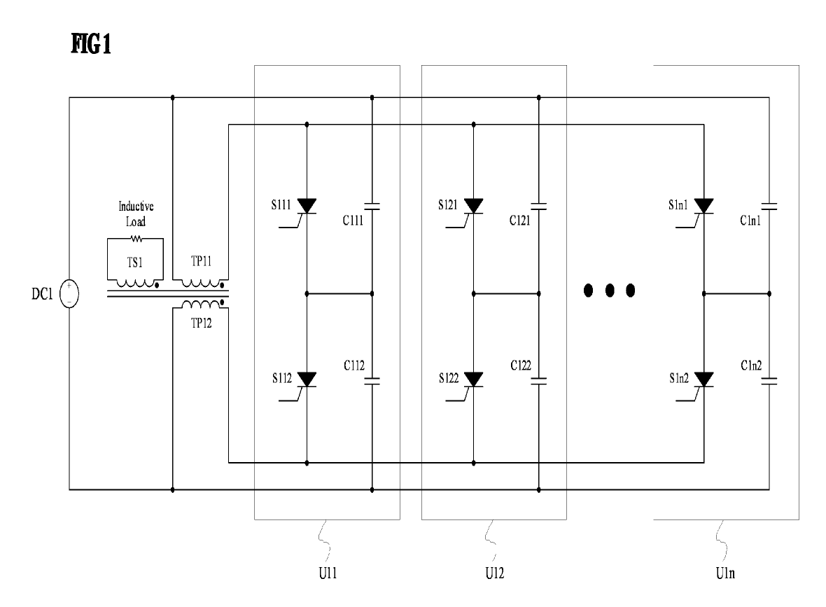

FIG. 1 is a circuit diagram of a high-frequency power supply according to one embodiment of the present invention. Referring to FIG. 1, the high-frequency power supply according to the present embodiment comprises a direct current (DC) voltage source DC1, a transformer having two primary windings TP11 and TP12 connected respectively to the anode and cathode of the DC voltage source DC1 and a secondary winding TS1 cooperating with the two primary windings TP11 and TP12 for providing a high-frequency output, and a plurality of half-wave bridge type oscillators U11, U12, . . . , U1n connected to the two primary windings TP11 and TP12 of the transformer and the anode and cathode of the DC voltage source DC1 so as to be operated in a time-sharing method.

Each of the half-wave bridge type oscillators U11, U12, . . . , U1n includes a first thyristor S111, S121, . . . , or S1n1 and second thyristor S112, S122, . . . , or S1n2 connected in series between the two primary windings TP11 and TP12 of the transformer, and a first capacitor C111, C121, . . . , or C1n1 and second capacitor C112, C122, . . . , or C1n2 connected in series between the anode and cathode of the DC voltage source DC1 and having an intermediate connection point connected to an intermediate connection point of the first thyristor S111, S121, . . . , or S1n1 and second thyristor S112, S122, . . . , or S1n2.

Preferably, the first and second thyristors are implemented by thyristors having only a turn-on capability. Alternatively, the first and second thyristors may be implemented by other types of thyristors having both turn-on and turn-off capabilities, such as a gate turn-off (GTO) thyristor.

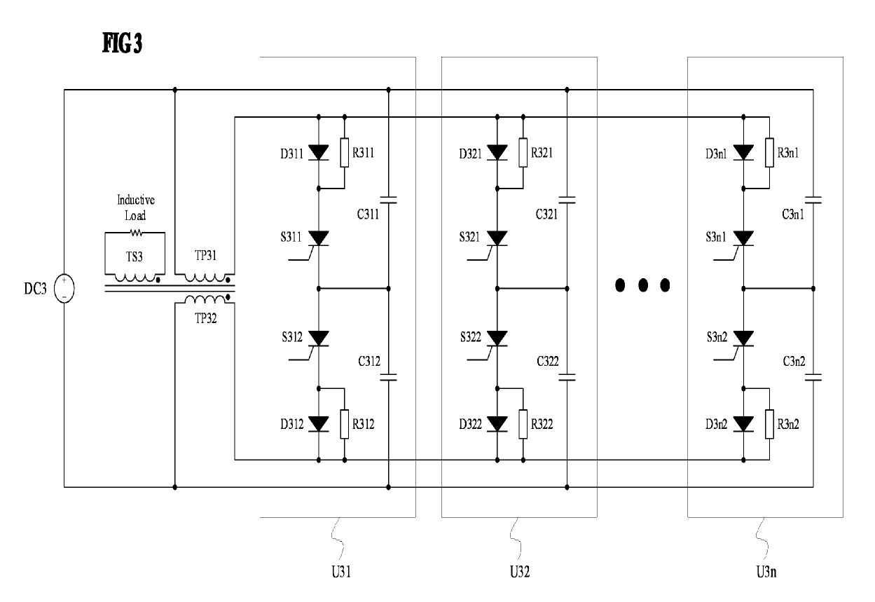

FIG. 3 is a circuit diagram showing an embodiment with the addition of an inductive kick prevention circuit to the embodiment of FIG. 1. As shown in this drawing, in order to prevent an inductive kick from being applied to each thyristor, each half-wave bridge type oscillator U31, U32, . . . , or U3n may further include a first fast recovery element D311, D321, . . . , or D3n1 connected in series to a first thyristor S311, S321, . . . , or S3n1, a first resistor R311, R321, . . . , or R3n1 connected in parallel with the first fast recovery element D311, D321, . . . , or D3n1, a second fast recovery element D312, D322, . . . , or D3n2 connected in series to a second thyristor S312, S322, . . . , or S3n2, and a second resistor R312, R322, . . . , or R3n2 connected in parallel with the second fast recovery element D312, D322, . . . , or D3n2.

Preferably, the first and second fast recovery elements are implemented by diodes or thyristors having a faster reverse recovery time characteristic trr than the series-connected first and second thyristors.

The operation of the high-frequency power supply of the present invention will hereinafter be described in detail with reference to FIG. 1.

First, when the first thyristor S111 of the first half-wave bridge type oscillator U11 is triggered to be turned on, current flows from the DC voltage source DC1 to the first capacitor C111 and second capacitor C112 via the primary winding TP11 of the transformer and the first thyristor S111, so as to charge the first capacitor C111 and second capacitor C112.

After a certain time elapses while the first and second capacitors C111 and C112 are charged as stated above, the voltage at the intermediate connection point of the first and second capacitors C111 and C112 rises, so that the first thyristor S111 is reverse-biased to be turned off.

Next, when the second thyristor S122 of the second half-wave bridge type oscillator U12 is triggered to be turned on, current flows from the DC voltage source DC1 to the first capacitor C121 and second capacitor C122 via the primary winding TP12 of the transformer and the second thyristor S122, so as to reversely charge the first capacitor C121 and second capacitor C122.

After a certain time elapses while the first and second capacitors C121 and C122 are reversely charged as stated above, the voltage at the intermediate connection point of the first and second capacitors C121 and C122 falls, so that the second thyristor S122 is reverse-biased to be turned off. In this manner, the first thyristor and second thyristor of each half-wave bridge type oscillator are operated in the opposite manner to each other up to the nth half-wave bridge type oscillator U1n of the last stage.

Next, when the second thyristor S112 of the first half-wave bridge type oscillator U11 is triggered to be turned on, current flows from the DC voltage source DC1 to the first capacitor C111 and second capacitor C112 via the primary winding TP12 of the transformer and the second thyristor S112, so as to reversely charge the first capacitor C111 and second capacitor C112. After the lapse of a certain time, the voltage at the intermediate connection point of the first and second capacitors C111 and C112 falls, so that the second thyristor S112 is reverse-biased to be turned off.

Next, when the first thyristor S121 of the second half-wave bridge type oscillator U12 is triggered to be turned on, current flows from the DC voltage source DC1 to the first capacitor C121 and second capacitor C122 via the primary winding TP11 of the transformer and the first thyristor S121, so as to charge the first capacitor C121 and second capacitor C122.

After the lapse of a certain time, the voltage at the intermediate connection point of the first and second capacitors C121 and C122 rises, so that the first thyristor S121 is reverse-biased to be turned off.

In this manner, the second thyristor and first thyristor of each half-wave bridge type oscillator are operated in the opposite manner to those described above up to the nth half-wave bridge type oscillator U1n of the last stage.

Therefore, when the switching operation is repeatedly performed as stated above, an alternating current (AC) output is generated in the secondary winding TS1 of the transformer, so that high-frequency current flows to an inductive load.

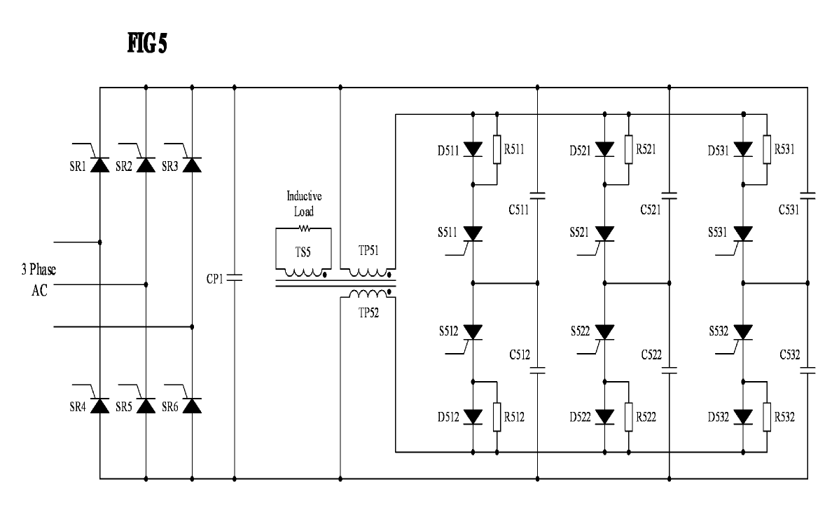

As an alternative, a three-phase half-wave bridge circuit may be provided which includes fast recovery elements connected in series to thyristors, respectively, and resistors connected in parallel with the fast recovery elements, respectively, as shown in FIG. 5. In this three-phase half-wave bridge circuit, it is possible to prevent an inductive kick from being applied to each thyristor and allow high-frequency current to flow at an output stage. A description of a switching operation of the three-phase half-wave bridge circuit will be omitted.

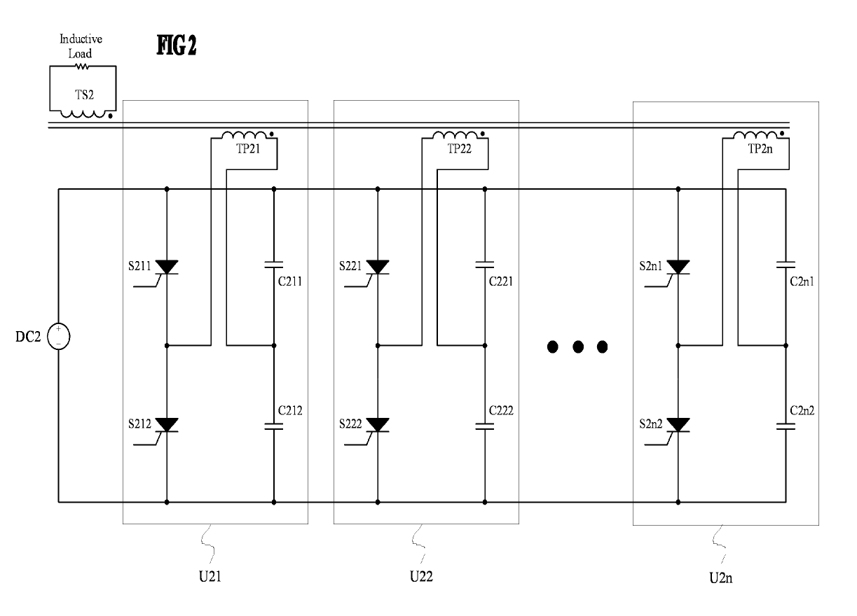

A detailed description will hereinafter be given of the circuit configuration of a high-frequency power supply according to an alternative embodiment of the present invention shown in FIG. 2. The high-frequency power supply according to this embodiment comprises a DC voltage source DC2, a transformer having a plurality of primary windings TP21, TP22, . . . , TP2n and a secondary winding TS2 cooperating with the primary windings TP21, TP22, . . . , TP2n for providing a high-frequency output, and a plurality of half-wave bridge type oscillators U21, U22, . . . , U2n connected respectively to the primary windings TP21, TP22, . . . , TP2n of the transformer and connected to the anode and cathode of the DC voltage source DC2 so as to be operated in a time-sharing method.

Each of the half-wave bridge type oscillators U21, U22, . . . , U2n includes a first thyristor S211, S221, . . . , or S2n1 and second thyristor S212, S222, . . . , or S2n2 connected in series between the anode and cathode of the DC voltage source DC2, and a first capacitor C211, C221, . . . , or C2n1 and second capacitor C212, C222, . . . , or C2n2 connected in series between the anode and cathode of the DC voltage source DC2 and having an intermediate connection point connected to an intermediate connection point of the first thyristor S211, S221, . . . , or S2n1 and second thyristor S212, S222, . . . , or S2n2 through a corresponding one of the primary windings TP21, TP22, . . . , TP2n of the transformer.

Preferably, the first and second thyristors are implemented by thyristors having only a turn-on capability. Alternatively, the first and second thyristors may be implemented by other types of thyristors having both turn-on and turn-off capabilities, such as a GTO thyristor.

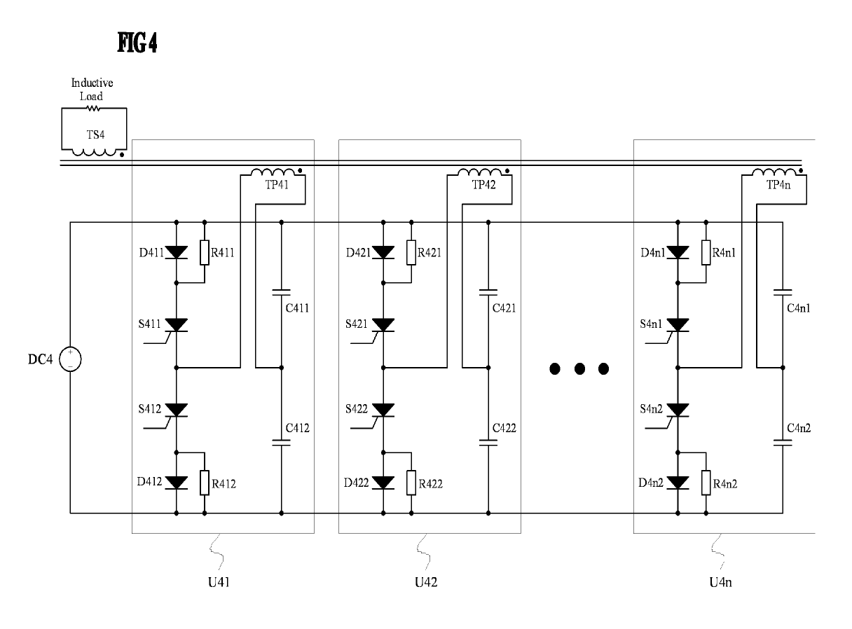

As an alternative, as shown in FIG. 4, in order to prevent an inductive kick from being applied to each thyristor, each half-wave bridge type oscillator U41, U42, . . . , or U4n may further include a first fast recovery element D411, D421, . . . , or D4n1 connected in series to a first thyristor S411, S421, . . . , or S4n1, a first resistor R411, R421, . . . , or R4n1 connected in parallel with the first fast recovery element D411, D421, . . . , or D4n1, a second fast recovery element D412, D422, . . . , or D4n2 connected in series to a second thyristor S412, S422, . . . , or S4n2, and a second resistor R412, R422, . . . , or R4n2 connected in parallel with the second fast recovery element D412, D422, . . . , or D4n2.

Preferably, the first and second thyristors are implemented by thyristors having only a turn-on capability. Alternatively, the first and second thyristors may be implemented by other types of thyristors having both turn-on and turn-off capabilities, such as a GTO thyristor.

Preferably, the first and second fast recovery elements are implemented by diodes or thyristors having a faster reverse recovery time characteristic trr than the series-connected first and second thyristors.

Hereinafter, a detailed description will be given of the operation of the above-stated high-frequency power supply of FIG. 2. First, when the first thyristor S211 of the first half-wave bridge type oscillator U21 is triggered to be turned on, current flows from the DC voltage source DC2 to the first capacitor C211 and second capacitor C212 via the first thyristor S211 and the primary winding TP21 of the transformer, so as to charge the first capacitor C211 and second capacitor C212. After a certain time elapses, the voltage at the intermediate connection point of the first and second capacitors C211 and C212 rises, so that the first thyristor S211 is reverse-biased to be turned off.

Next, when the second thyristor S222 of the second half-wave bridge type oscillator U22 is triggered to be turned on, current flows from the DC voltage source DC2 to the first capacitor C221 and second capacitor C222 via the second thyristor S222 and the primary winding TP22 of the transformer, so as to reversely charge the first capacitor C221 and second capacitor C222. After the lapse of a certain time, the voltage at the intermediate connection point of the first and second capacitors C221 and C222 falls, so that the second thyristor S222 is reverse-biased to be turned off.

In this manner, the first thyristor and second thyristor of each half-wave bridge type oscillator are operated in the opposite manner to each other up to the nth half-wave bridge type oscillator U2n of the last stage.

Next, when the second thyristor S212 of the first half-wave bridge type oscillator U21 is triggered to be turned on, current flows from the DC voltage source DC2 to the first capacitor C211 and second capacitor C212 via the second thyristor S212 and the primary winding TP21 of the transformer, so as to reversely charge the first capacitor C211 and second capacitor C212. After the lapse of a certain time, the voltage at the intermediate connection point of the first and second capacitors C211 and C212 falls, so that the second thyristor S212 is reverse-biased to be turned off.

Next, when the first thyristor S221 of the second half-wave bridge type oscillator U22 is triggered to be turned on, current flows from the DC voltage source DC2 to the first capacitor C221 and second capacitor C222 via the first thyristor S221 and the primary winding TP22 of the transformer, so as to charge the first capacitor C221 and second capacitor C222.

After a certain time elapses while the first and second capacitors C221 and C222 are charged as stated above, the voltage at the intermediate connection point of the first and second capacitors C221 and C222 rises, so that the first thyristor S221 is reverse-biased to be turned off.

In this manner, the second thyristor and first thyristor of each half-wave bridge type oscillator are operated in the opposite manner to those described above up to the nth half-wave bridge type oscillator U2n of the last stage.

Therefore, when the switching operation is repeatedly performed as stated above, an AC output is generated in the secondary winding TS2 of the transformer, so that high-frequency current flows to an inductive load.

On the other hand, when a thyristor is turned off, reverse recovery current flows through the thyristor for a reverse recovery time trr. In an inductive circuit, an inductive kick is generated at the moment that the thyristor is completely turned off while the reverse recovery current flows. In some cases, the inductive kick may be several times as high as a normal voltage, so that it may exceed a withstand voltage of the thyristor, resulting in damage to the thyristor.

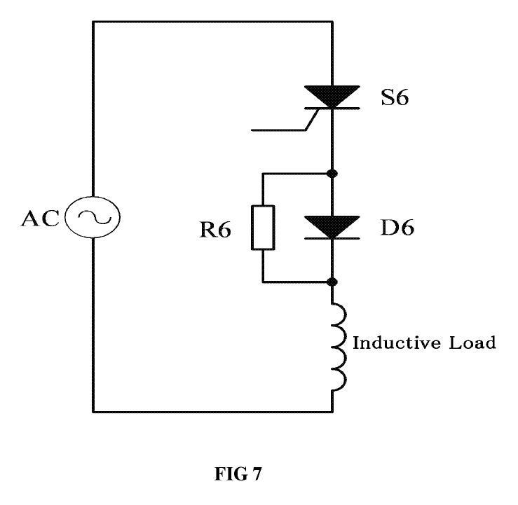

In order to prevent each thyristor from being damaged in this manner, according to the present invention, fast recovery elements may be connected in series to thyristors, respectively, and resistors may be connected in parallel with the fast recovery elements, respectively, as shown in FIG. 7. Here, the fast recovery elements have a faster reverse recovery time characteristic than the thyristors.

As a result, because the fast recovery element is turned off earlier than the series-connected thyristor, the inductive kick is applied to the fast recovery element and then reduced through the resistor connected in parallel with the fast recovery element. The location of the fast recovery element may be modified freely based on the above-stated principle.

In another embodiment of the present invention, the same number of loads as that of the primary windings of the transformer may be directly connected instead of using the transformer. Although the number of half-wave bridge type oscillators may be determined as a random number in manufacturing the high-frequency power supply, it is preferable that it is determined as an odd number to obtain an accurate AC output waveform.

As apparent from the above description, in a high-frequency power supply according to the present invention, a plurality of half-wave bridge type oscillators are operated in a time-sharing method to generate a high frequency. As a result, the reverse bias hold time of each thyristor is increased to several times that of a conventional single-phase full-wave bridge circuit at the same oscillating frequency. Therefore, it is possible to stably output a frequency and power which are several times as high as those in the conventional power supply, using a thyristor having the same turn-off time characteristic tq.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A high-frequency power supply comprising:
a direct current (DC) voltage source;
a transformer having two primary windings connected respectively to an anode and cathode of the DC voltage source and a secondary winding cooperating with the two primary windings for providing a high-frequency output; and
a plurality of half-wave bridge type oscillators, each comprising first and second thyristors which are connected in series between the two primary windings of the transformer, and first and second capacitors which are connected in series between the anode and cathode of the DC voltage source and having an intermediate connection point connected to an intermediate connection point of the first and second thyristors.

2. The high-frequency power supply according to claim 1, wherein the first and second thyristors are gate turn-off thyristors.

3. The high-frequency power supply according to claim 1, wherein each of the half-wave bridge type oscillators further comprises:
a plurality of fast recovery elements connected in series to the first and second thyristors, respectively, each of the fast recovery elements having a faster reverse recovery time characteristic than each of the first and second thyristors; and
a plurality of resistors connected in parallel with the fast recovery elements, respectively,
whereby an inductive kick is prevented from being applied to each of the first and second thyristors.

4. A high-frequency power supply comprising:
a DC voltage source;
a transformer having a plurality of primary windings and a secondary winding cooperating with the primary windings for providing a high-frequency output; and
a plurality of half-wave bridge type oscillators, each comprising first and second thyristors which are connected in series between an anode and cathode of the DC voltage source, and first and second capacitors which are connected in series between the anode and cathode of the DC voltage source and having an intermediate connection point connected to an intermediate connection point of the first and second thyristors through a corresponding one of the primary windings of the transformer.

5. The high-frequency power supply according to claim 4, wherein the first and second thyristors are gate turn-off thyristors.

6. The high-frequency power supply according to claim 4, wherein each of the half-wave bridge type oscillators further comprises:
a plurality of fast recovery elements connected in series to the first and second thyristors, respectively, each of the fast recovery elements having a faster reverse recovery time characteristic than each of the first and second thyristors; and
a plurality of resistors connected in parallel with the fast recovery elements, respectively,
whereby an inductive kick is prevented from being applied to each of the first and second thyristors.
